(19) United States
(12) Patent Application Publication
(10) Pub. No.: US 2023/0189046 A1
(43) Pub. Date: Jun. 15, 2023

(54) CELL MEASUREMENT REPORTING SCHEMES IN WIRELESS COMMUNICATIONS

(71) Applicant: ZTE Corporation, Shenzhen (CN)

(72) Inventors: Liping Liu, Shenzhen (CN); Shujuan Zhang, Shenzhen (CN); Bo Gao, Shenzhen (CN); Chuangxin Jiang, Shenzhen (CN); Shuaihua Kou, Shenzhen (CN); Zhaohua Lu, Shenzhen (CN)

(21) Appl. No.: 18/167,335

(22) Filed: Feb. 10, 2023

Related U.S. Application Data
(63) Continuation of application No. PCT/CN2020/116083, filed on Sep. 18, 2020.

(51) Int. Cl. H04W 24/10; H04W 72/12; H04W 72/566

(52) U.S. Cl. CPC H04W 24/10; H04W 72/12; H04W 72/566

(57) ABSTRACT

A method of wireless communication is described. The method is performed by a user device and comprises obtaining a first measurement information of a first protocol layer; making a determination, based on the first measurement information, whether a predefined condition is satisfied; and triggering a transmission of an element of a second protocol layer based on the determination that the predefined condition is satisfied, and wherein the element of the second protocol layer includes at least one of control information of the second protocol layer or a second measurement information of the second protocol layer.

### CROSS REFERENCE TO RELATED APPLICATIONS

This patent document is a continuation of and claims benefit of priority to International Patent Application No. PCT/CN2020/116083, filed on Sep. 18, 2020. The entire content of the before-mentioned patent application is incorporated by reference as part of the disclosure of this application.

### TECHNICAL FIELD

This patent document generally relates to systems, devices, and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices.

### SUMMARY

This document relates to methods, systems, and devices for cell measurement reporting schemes in wireless communications.

In one aspect, a wireless communication method is disclosed. The wireless communication method is performed by a user device and comprises: obtaining a first measurement information of a first protocol layer; making a determination, based on the first measurement information, whether a predefined condition is satisfied; and triggering a transmission of an element of a second protocol layer based on the determination that the predefined condition is satisfied, and wherein the element of the second protocol layer includes at least one of control information of the second protocol layer or a second measurement information of the second protocol layer.

In another aspect, a wireless communication method is disclosed. The wireless communication method is performed by a user device and comprises: determining measurement information of a protocol layer; and transmitting a control information including the measurement information, and wherein the protocol layer is a physical layer or a medium access control layer and the measurements information is for at least one of a neighboring cell or a serving cell.

In another aspect, a wireless communication method is disclosed. The wireless communication method is performed by a user device and comprises: receiving, from a network device, first information; and determining, based on the first information, a parameter of a control resource set, and wherein the parameter includes at least one of: an index of the control resource set or a state of the control resource set and wherein the first information includes at least one of MAC-CE (MAC Control Element), DCI (downlink control information), or PCI (physical layer cell ID) of the control resource set.

In another aspect, a wireless communication apparatus comprising a processor configured to perform the disclosed methods is disclosed.

In another aspect, a computer readable medium having code stored thereon is disclosed. The code, when implemented by a processor, causes the processor to implement a method described in the present document.

These, and other features, are described in the present document.

### BRIEF DESCRIPTION OF THE DRAWING

FIGS. 1 and 2 show example operations performed by a user equipment (UE) and including triggering a control transmission including MAC-CE or SR based on RRC measurement in some implementations of the disclosed technology.

FIGS. 3 and 4 show example operations performed by UE and including triggering a control transmission including a UCI or SR based on RRC measurement in some implementations of the disclosed technology.

FIGS. 5 and 6 show examples of MAE-CE that includes PCIs and a L1 measurement information for each PCI, wherein all the PCI corresponds one MeasID.

FIG. 7 shows an example of MAE-CE that includes PCIs without including L1 measurement information in the MAC-CE, wherein the L1 measurement quality of the PCI is higher than a threshold.

FIGS. 8 and 9 show examples of MAC-CE that includes a L1 measurement information for a reference signal resource of each PCI and a reference signal source index of each PCI.

FIG. 10 shows an example of MAC-CE that includes a reference signal source index of each PCI without including L1 measurement information in the MAC-CE and L1 measurement information of the reference signal source index is higher than a threshold.

FIG. 11 shows an example of MAC-CE that includes two L1 measurement information for two reference signal source indexes for each PCI.

FIG. 12 shows an example of MAC-CE that includes PCIs and two reference signal source indices of each PCI without including L1 measurement information which is higher than a threshold.

FIG. 13 shows an example of MAC-CE that includes at least one serving cell index, neighboring cell PCI for each serving cell, one or more L1 measurement information for each neighboring cell PCI, and a reference signal resource index of each L1 measurement information.

FIG. 14 shows an example of MAC-CE that includes at least one serving cell index, neighboring cell PCI for each serving cell, and a reference signal resource index of each L1 measurement information without including L1 measurement information which is higher than a threshold.

FIG. 15 shows an example of MAC-CE that includes at least one MeasID, at least one neighboring cell PCI for each MeasID, one or more L1 measurement information for each neighboring cell PCI, and a reference signal resource index of each L1 measurement information.

FIG. 16 shows an example of MAC-CE that includes at least one MeasID, at least one neighboring cell PCI for each MeasID, and a reference signal resource index of each L1 Measurement information without including L1 Measurement information which is higher than a threshold.

FIGS. 17A to 17C show example flowcharts showing cell measurement reporting schemes based on some implementations of the disclosed technology.

FIG. 18 shows an example of wireless communication including a base station (BS) and user equipment (UE) based on some implementations of the disclosed technology.

FIG. 19 shows an example of a block diagram of a portion of an apparatus based on some implementations of the disclosed technology

### DETAILED DESCRIPTION

The disclosed technology provides implementations and examples of cell measurement reporting schemes in wireless communications. While 5G terminology is used in some cases to facilitate understanding of the disclosed techniques, which may be applied to wireless systems and devices that use communication protocols other than 5G or 3GPP protocols.

The disclosed technology provides various implementations that are related to measurement reporting, for example, a reporting of Layer (L1) measurement based on Layer 3 (L3) measurement. The following examples are discussed to facilitate understanding of various implementations.

### EXAMPLE 1

There is a relationship between Layer 3 (L3) measurement and a control transmission. The relationship may define that the control transmission is triggered by the L3 measurement and the relationship can be configured/determined using at least one of Scheme A and Scheme B that are further discussed later in this patent document.

The control information that is included in the control transmission is used for reporting of the L1/L2/L3 measurement. The control information may include a Layer 2 control information or a Layer 1 control information. The control transmission may include a MAC-CE (MAC Control Element), SR (Scheduling Request), and/or UCI (Uplink Control Information) transmission. The MAC-CE/SR/UCI transmission may be used by a UE (user equipment) for at least one of 1) reporting L1 measurement information or 2) reporting L3 measurement information, or 3) reporting L2 measurement information. The reporting in the control information can be about a serving cell and/or about a neighboring cell. For example, if the reporting in the control information is a L1 measurement information and if a predefined condition based on L3 measurement is satisfied, the L3 layer of UE will directly trigger the UE to report Layer 1 (L1) measurement information without waiting for a signaling from BS (base station). The predefined condition based on L3 measurement will be discussed later in this patent document. The L3 layer measurement can be for mobility management. The L1 measurement information may be not filtered by L3 layer filter whose parameter is configured by gNB or predefined. The L1 measurement information comprise at least one of following: RSRP (Reference Signal Receiving Power), SINR (Signal to Interference plus Noise Ratio), CQI (Channel Quality Indicator), PCI (Physical cell index) whose L1 quality is higher a threshold, a reference signal resource index whose L1 quality is higher a threshold, a serving cell index whose L1 quality is higher a threshold.

In some implementations, the L1 measurement information which has a relationship with a L3 layer mobility measurements is a L1 measurement information of a neighboring cell. In the similar manner, the L1 measurement information can be L1 measurement information of a serving cell.

In some implementations, the UE reports the L1 measurement information using one of following method.

Method 1: If the predefined condition based on L3 measurement layer of the UE is satisfied, the L3 layer of the UE will instruct the MAC layer of the UE to report L1 measurement. The L1 measurement information is in a MAC-CE included in a PUSCH (Physical Uplink Shared Channel), and the UE transmits the PUSCH including the MAC-CE to report the L1 measurement information which is triggered by the predefined condition based on L3 measurement. The L1 measurement information in the MAC-CE can also be named L2 measurement information. The measurement information in the MAC-CE is the measurement information obtained from the physical layer of the UE. The PHY layer of the UE gives the L1 measurement information to the MAC layer of the UE. The MAC layer of the UE includes the L1 measurements in the MAC-CE. In some implementations, the MAC layer of the UE filters the L1 measurement using a MAC layer filter. If UL-SCH is available, the L2 layer (i.e., MAC layer) at UE instructs the multiplexing and assembly procedure to generate the MAC CE including the L1 measurement information, and otherwise, the UE transmits a SR (Scheduling Request) for MAC-CE reporting which is triggered by L3 mobility measurements, and the UE transmits the MAC-CE in a PUSCH which is scheduled by the gNB (e.g., the base station).

Method 2: Method 2 is similar as Method 1 but differs from Method 1 in terms of the condition to trigger a SR for reporting the L1 measurement information in a MAC-CE. If the MAC-CE includes a L1 measurement information with a predefined character and the UL-SCH is unavailable, the UE triggers the SR for reporting the L1 measurement information, and otherwise, the UE waits for an available UL-SCH to report the MAC-CE without transmits the SR. The SR is to request PUSCH, and then the UE includes the MAC-CE in a PUSCH scheduled by a gNB. If the MAC-CE includes a L1 measurement information without the predefined character and the UL-SCH is unavailable, the UE will not trigger the SR for reporting the L1 measurement information. In this case, the UE only waits for an available UL-SCH to report the MAC-CE. In some implementations, the L1 measurement information with the predefined character includes L1 measurement information of a neighboring cell. In some other implementations, the L1 measurement information with the predefined character includes L1 measurement information of a neighboring cell with a predefined character. The neighboring cell with a predefined character includes at least one of following neighboring cell: a neighboring cell corresponding to a serving cell; a best neighboring cell corresponding to a serving cell; a neighboring cell corresponding to a predefined serving cell; a best neighboring cell corresponding to a predefined serving cell; or the best N neighboring cell associated with a measID. The measID can be predefined and N is a positive integer which is i) predetermined, ii) determined by a signaling from gNB, and/or iii) determined based on whether the measurement information of a neighboring cell is higher than a threshold. The predefined serving cell includes at least one of: SpCell (Special serving cell that can be a primary serving cell or a second primary serving cell); M serving cell(s) determined by a signaling from a gNB; worst M serving cell(s); M serving cell(s) whose quality is lower than a threshold; best M serving cell(s); M serving cell(s) whose quality is higher than a threshold. The M is a positive integer.

Method 3: The L1 measurement information is included in a UCI transmitted by the UE to a gNB. If the predefined condition based on L3 measurements is satisfied, the L3 layer of the UE will directly instruct the UE to transmit the L1 measurement information included in a UCI to gNB. In some implementations, the UE can first trigger a SR for reporting the L1 measurement information and then transmit a PUSCH/PUCCH (physical uplink control channel) including a UCI comprising the L1 measurement information.

Method 4: Method 4 is similar as Method 3 but differs from Method 3 in that the UCI also includes a piece of information about whether the L1 measurement information triggered by the L3 measurement is in the UCI. Because the UCI is event triggered, the UE needs to let the gNB to know whether the UE includes the L1 measurement information triggered by the L3 measurement in the current UCI.

In the implementations above, the SR for reporting L1 measurement which is triggered by a L3 measurements is transmitted in a dedicated PUCCH resource configured by the gNB for the reporting.

The relationship between L3 layer measurement and the control transmission is configured using at least one of Scheme A and Scheme B. After the relationship is configured, the UE can determine to transmit control information according to the L3 measurement associated with the relationship.

Scheme A: gNB configures a L3 measurement parameter for the control transmission. The L3 measurement parameter is used to trigger the control transmission.

If the control transmission corresponds to a MAC-CE transmission, the gNB configures the L3 measurement parameter for the MAC-CE or for the SR in order to configure the relationship between L3 layer measurement and the MAC-CE transmission. The MAC-CE or the SR is triggered when the condition based on L3 measurements corresponding to the L3 measurement parameter is satisfied. If the control transmission corresponds to a UCI transmission, the gNB configures the L3 measurement parameter for a CSI-ReportConfig in order to configure the relationship between L3 layer measurement and the UCI transmission. The CSI-ReportConfig also includes other parameter to determine the resource (such as PUCCH resource) and a way to report the UCI (such as time domain behavior, such as aperiodic, semi-periodic, periodic, etc.). The UCI is triggered when the condition of L3 measurements corresponding to the L3 measurement parameter is satisfied. The MAC-CE or the SR or the UCI is triggered based on the condition of L3 measurement corresponding to the L3 measurements parameter instead of being triggered by a signaling received from a gNB. The MAC-CE or the SR or the UCI can be for at least one of: L1 measurement information reporting, L2 measurement information reporting, L3 measurements result reporting. The MAC-CE or the SR or the UCI can include the measurement information of a serving cell and/or a neighboring cell.

The predefined condition of L3 measurement corresponding to the L3 measurements parameter includes the condition that can trigger the UE to report a L3 measurement information corresponding to the L3 measurement parameter, regardless of whether or not the UE actually reports the L3 measurement information.

When the MAC-CE/UCI includes the L1/L2 measurement information, some of L1/L2 measurement information in the MACC-CE can got based on the L3 measurement information. For example the PCI associated with the L1/L2 measurement information should belong to the PCI set for the L3 measurement. The L3 measurement information may be reported by the UE using L3 measurement report way instead of using the MAC-CE/UCI.

In some implementations, the predefined condition of L3 measurement corresponding to the L3 measurements parameter includes the condition that the UE will report a L3 measurement information corresponding to the L3 measurements parameter.

In some implementations, the predefined condition of L3 measurement corresponding to the L3 measurement parameter includes the condition of a L3 event which is one of following: Event A3 (neighbor becomes offset than a special cell (SpCell)); Event A5 (SpCell becomes worse than threshold1 and neighbor becomes better than threshold2); Event B2 (a primary serving cell (PCell) becomes worse than threshold1 and inter RAT neighbor becomes better than threshold2); Event A6 (Neighbor becomes offset6 than a secondary cell (Scell)); Event A2 (a serving cell becomes worse than threshold); Event A4 (Neighbor becomes better than threshold); Event A1 (the serving cell becomes better than threshold); Event D1 (the serving cell is better than the threshold and the neighboring cell is also better than the threshold); Event D2 (the serving cell is lower than the threshold and at least two neighboring cells are better than the threshold); Event D3 (at least two neighboring cells are better than the threshold).

Scheme B: It is similar as the Scheme A except that the L3 measurement parameter is predefined instead of being determined by a signaling from a gNB.

The L3 measurement parameter in Scheme A and Scheme B includes at least one of following parameters:

### Parameter 1: MeasID

The MeasID is used to setup a link between a MeasureObject and a ReportConfig. The MeasObject is used to configure the measurement reference signal resource at least for L3 measurements. The ReportConfig is used to configure the condition and the way to report the L3 measurement. If the condition based on L3 measurement corresponding to the MeasID is satisfied (for example, the condition which triggers the UE to report a L3 measurement is satisfied, the condition is based on the parameter of ReportConfig and MeasureObject associated with the MeasID), the L3 layer at UE side automatically trigger the control transmission without waiting for a signaling from gNB. While the UE reports the L1 measurement information in the control information, the UE can also report the L3 measurement information in a Layer 3 measurement reporting in parallel, or the UE can skip reporting of the L3 measurement information in a Layer 3 measurement reporting.

### Parameter 2: Serving Cell Index

If the condition based on L3 measurement corresponding to the serving cell with the serving cell index is satisfied, the L3 layer at UE side automatically triggers the control transmission without waiting for a signaling from gNB. For example, the quality of the serving cell is lower than a threshold and the UE has found a best neighboring cell for the serving cell, the Layer 3 of the UE will directly instruct the UE to transmit the control information.

### Parameter 3: Event Index

If the condition of the event is satisfied, the L3 layer at UE side automatically triggers the control transmission without waiting for a signaling from gNB. The event includes at least one of L3 measurement event: Event A3 (neighbour becomes offset than SpCell); Event A5 (SpCell becomes worse than threshold1 and neighbour becomes better than threshold2); Event B2 (PCell becomes worse than threshold1 and inter RAT neighbour becomes better than threshold2); Event A6 (Neighbour becomes offset6 than Scell); Event A2(Serving becomes worse than threshold); Event A4 (Neighbour becomes better than threshold); Event A1 (Serving becomes better than threshold); Event D1 (the serving cell is better than the threshold and the neighboring cell is better than the threshold); Event D2 (the serving cell is lower than the threshold and at least two neighboring cells is better than the threshold); Event D3 (at least two neighboring cells is better than the threshold).

### Parameter 4: MeasObjectID

If there is Layer 3 reporting associated with the MeasObjectID, then the Layer 3 of UE will instructs the Layer 1/Layer 2 of the UE to transmits the control information.

### Parameter 4: ReportingID

If there is Layer 3 reporting associated with the ReportingID, then the Layer 3 of UE will instructs the Layer 1/Layer 2 of the UE to transmits the control information. The Reporting is Layer 3 measurement reporting.

If the control transmission is triggered, the UE can transmit the control information once, or the UE can periodically transmit the control information, or the UE can periodically transmit the control information for predefined time or until a condition to stop the transmission is satisfied. For example, the control information is for L1 measurement reporting and if L1 measurement reporting is triggered based on the relationship, the UE can report the L1 measurement information once, or the UE can periodically report the L1 Measurement information, or the UE can periodically report the L1 measurement information for predefined time or until the condition to stop reporting is satisfied. The gNB can configure the time domain behavior parameter for the control transmission. For example, the time domain behavior parameter may include at least one of: period, offset, transmission number, the condition to stop. The condition to stop may be satisfied when the predefined condition corresponding to the L3 parameter is satisfied again, or when the neighboring cell of the control information has been a serving cell, and/or when the gNB has triggered another control transmission for the neighboring cell using a signaling to report the measurement of the neighboring cell.

In some implementations, the L1 measurement information may be not filtered by the L3 filter. The L1 measurement information includes a L1 measurement information of a serving cell, and/or a L1 measurement information of a neighboring cell. The L3 measurement includes L3 measurement for mobility. The L3 measurement information may be filtered by the L3 filter. The L3 measurement information can also include other types of L3 measurement information.

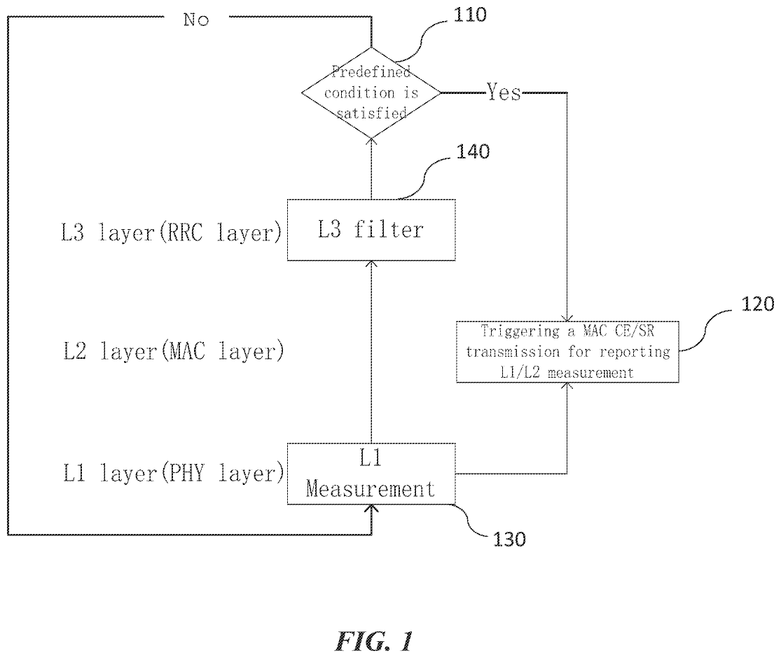

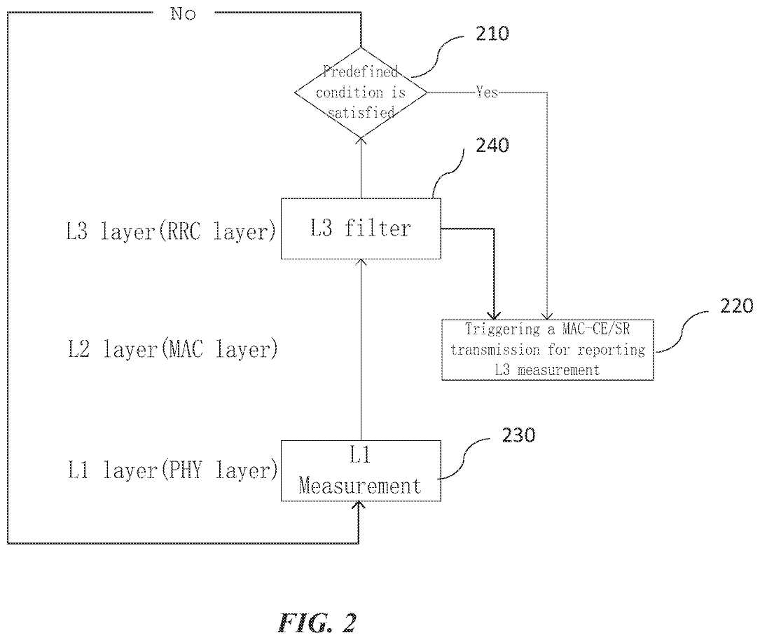

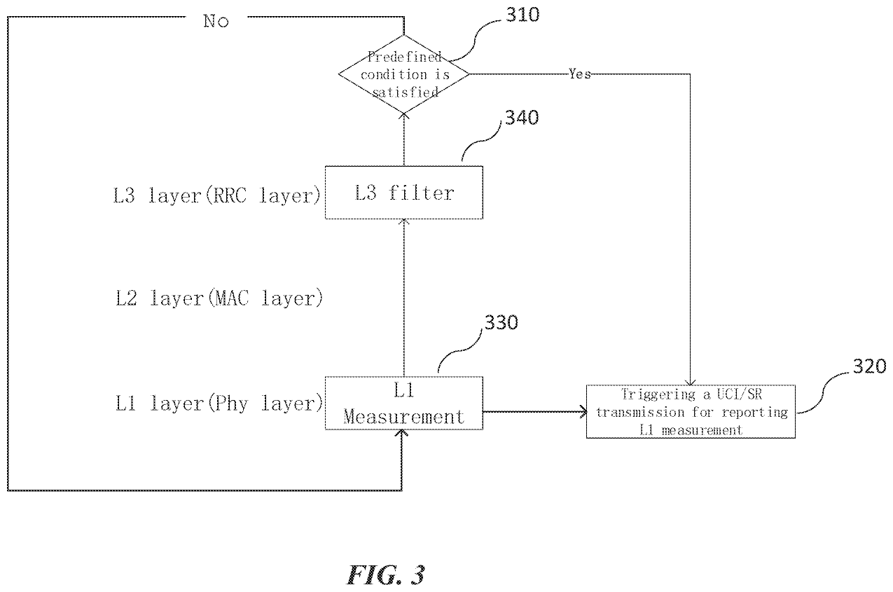

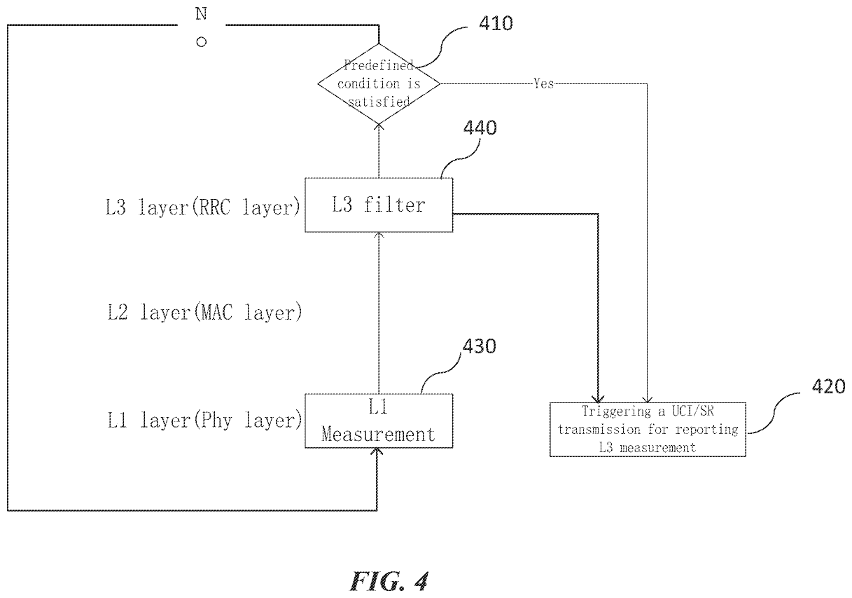

If the predefined condition based on L3 measurement information of mobility reference signal is satisfied, the L3 layer at UE side automatically triggers the control transmission according to the relationship between the L3 measurement and the control transmission without waiting for a signaling from gNB as shown in FIGS. 1 to 4. FIG. 1 shows example operations by the UE based on some implementations of the disclosed technology. At 110, the UE determined whether the predefined condition based on L3 measurement information is satisfied. If it is determined that the predefined condition is satisfied, the UE proceeds to step 120 and triggers the control transmission that is the MAC-CE or SR for reporting L1/L2 measurement. If it is determined that the predefined condition is not satisfied, the UE proceeds to step 130 and receives the L1 measurement information. The L1 measurement information is filtered by L3 filter at step 140 and the operation 110 is repeated. When the UE is triggered to transmit the MAC-CE, the PHY layer of the UE will give the L1 measurement information to the MAC layer of the UE. The L1 measurement information will be included in the MAC-CE. Or the L1 measurement result will be filtered at the MAC layer and then included in the MAC-CE measurement information. FIG. 2 shows example operations by the UE based on some implementations of the disclosed technology. The operations in FIG. 2 are different from those in FIG. 1 in that the L3 filtered result is included in the control transmission, i.e., the L3 measurement information is included in the MAC-CE. FIG. 3 shows example operations by the UE based on some implementations of the disclosed technology. The operations in FIG. 3 are different from those in FIG. 1 in that the control transmission corresponds to the UCI or SR. FIG. 4 shows example operations by the UE based on some implementations of the disclosed technology. In FIG. 4, the control transmission corresponds to the UCI or SR and the L3 filtered result is included in the control transmission. A L3 measurement information reporting in Layer 3 can be reported by the UE, or the L3 measurement information reporting in Layer 3 will not be reported by the UE while the UE transmits the control information of Layer 2 or Layer 1 triggered by the predefined condition.

When the control information includes a L1 measurement information of a neighboring cell, the reference signal resource for the L1 measurement information and the reference signal resource for L3 measurement can be same or different. If the reference signal resource for the L1 measurement information and the reference signal resource for L3 measurement are same, the L1 measurement information of the neighboring cell is based on a mobility reference signal resource of the neighboring cell configured in a MeasObject. The MeasObject will configure a mobility reference signal resource set for each of multiple neighboring cells. The mobility reference signal resource includes SSB (a synchronization signal/Physical broadcast channel block) and/or CSI-RS(Channel state information-Reference signal) for mobility. If the reference signal resource for the L1 measurement information and the reference signal resource for L3 measurement are different, the L1 measurement information isn't got on the mobility reference signal resource of the neighboring cell configured in MeasObject, or the MeasObject will configure two reference signal resource sets for a neighboring cell, the two reference signal resource set used for L1 measurements and L3 measurements respectively. The L1 measurement can be based on the reference signal resource and other reference signal configured in CSI-Reporting.

A neighboring cell corresponds at least one of following parameter: a PCI, a SSB frequency location, a CSI-RS frequency location, MeasObject. The parameter of a neighboring cell and the parameter of a severing cell will be different, or configured respectively. For example at least one of PCI, SSB frequency location, CSI-RS frequency location, MeasObject is different between the serving cell and the neighboring cell.

In above implementation, the L3 measurement information is used to find the good neighboring cell, and the UE will automatically transmit the control information to quickly report the measurement of the neighboring cell as long as the predefined L3 measurement condition is satisfied. The UE can quickly report the Layer 2 measurements result or Layer 1 measurement information of neighboring cell to gNB. Then, the neighboring cell can transmit a channel to the UE based on the L1/L2 measurement information reported by the UE. Even if the control transmission only includes the L3 measurement information, it will speed up to report the L3 measurement information as the control transmission has higher priority than a normal data from Layer 3.

Using above method, a relationship between L3 measurement and at least one of MAC-CE, SR, UCI transmission has been set up. When the predefined condition based on L3 measurement is satisfied, the Layer 3 of the UE will trigger the UE to transmit at least one of MAC-CE, SR, UCI. The MAC-CE or the UCI will include at least one of following: 1) L1 Measurement information of a cell; 2) information of a cell whose L1 measurement information is higher than a threshold such as PCI of the cell, frequency location of the cell, MeasObject/MeasID of the cell; 3) L3 measurement information of a cell; 4) information of a cell whose L3 measurement information is higher than a threshold; 5) the reference signal resource index corresponding to each PCI, wherein the cell can be a neighboring cell or a serving cell. It accelerates measurement information reporting and/or mobility measurement information reporting.

It will accelerate the inter-cell mobility speed. It also can improve the robust of the inter-cell mobility as the UE can receive the signal both from serving cell and neighboring cell. The neighboring cell can transmits a channel to the UE using a beam based on the reference signal resource index of the neighboring cell reported by the UE.

The UCI can be included in a PUCCH resource which is configured by signaling from a gNB. The PUCCH resource can be configured associated with the L3 measurement parameter. In some implementations, the PUCCH resource can be configured in CSI-Reporting which is associated with the L3 measurement parameter.

### EXAMPLE 2

In this example, the MAC-CE or UCI can be configured to include L1 measurement information of at least one neighboring cell. In addition, the reporting of the L1 measurement information can be triggered by L3 measurement as described in Example 1 or triggered by a signaling received from a gNB, or triggered by a signaling from a gNB and L1 measurement of a serving cell or of a neighboring cell, where the MAC-CE or UCI will be triggered as long as the L1 measurement information of the serving cell is lower than a threshold and/or the L1 measurement information of the neighboring cell is higher than a threshold. The MAC-CE or UCI can also be triggered when the UE detects a beam failure.

The following example methods describe formats of the MAC-CE that can report L1 measurement information of at least one neighboring cell:

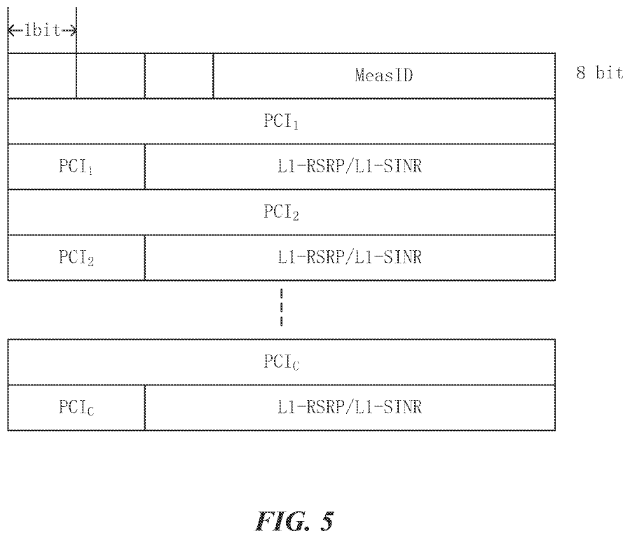

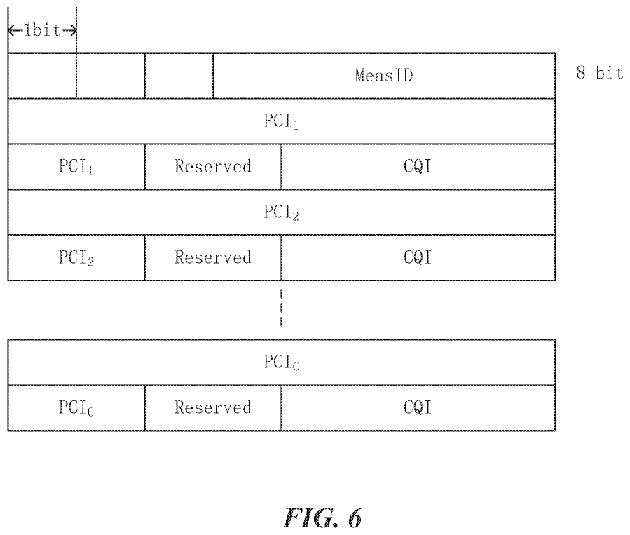

Method 1: The MAC-CE includes following information: one MeasID or one MeasObjectID, at least one PCI (Physical Cell ID) for a neighboring cell and/or a serving cell, and/or L1 measurement information for each PCI. FIGS. 5 and 6 show an example of MAE-CE that includes MeasID, PCIs and L1 measurement information for each PCI. Each PCI corresponds to one L1 measurement information which is the average L1 measurement information of multiple reference signal whose L1 measurement information is higher than a threshold so that the MAC-CE doesn't include the reference signal resource index (CRI/SSB-RI). The type of L1 measurement information is included in the MAC-CE depends on a configuration of gNB. Types of the L1 measurement information include L1 -RSRP, L1 -SINR, and/or CQI (Channel Quality Information). In some implementations, the L1 measurement information may include L1 -RSRP, L1 -SINR and not include CQI (as shown in FIG. 5). In some implementations, the L1 measurement information may include CQI and not include L1 -RSRP, L1 -SINR (as shown in FIG. 6).

In some implementations, the UE can also report the reference signal resource index of L1 measurement information. In some implementations, the UE reports reference signal resource index whose L1 measurement is higher than a threshold. In this case, the UE doesn't reports the L1 measurement information of the reference signal resource, the gNB will know that the L1 measurements result of the reference signal resource is higher than the threshold. All the PCI corresponds to the MeasID, for example, the MeasObject of the MeasID includes a reference signal resource for each of these PCIs.

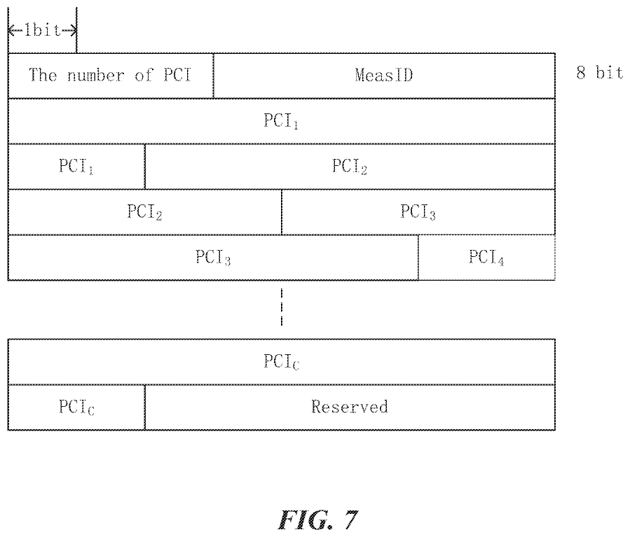

Method 2: The MAC-CE includes following information: one MeasID or one MeasObjectID, and/or at least one PCI. FIG. 7 shows an example of MAE-CE that includes MeasID and PCIs without L1 measurement information for each PCI. Although no L1 measurement information is included for each PCI in the MAC-CE, but the gNB will know that the L1 measurement information of each of these PCI is higher than a threshold after it receives the MAC-CE from the UE. If the L1 measurement information of a PCI isn't higher than the threshold, the PCI will not be included in the MAC-CE.

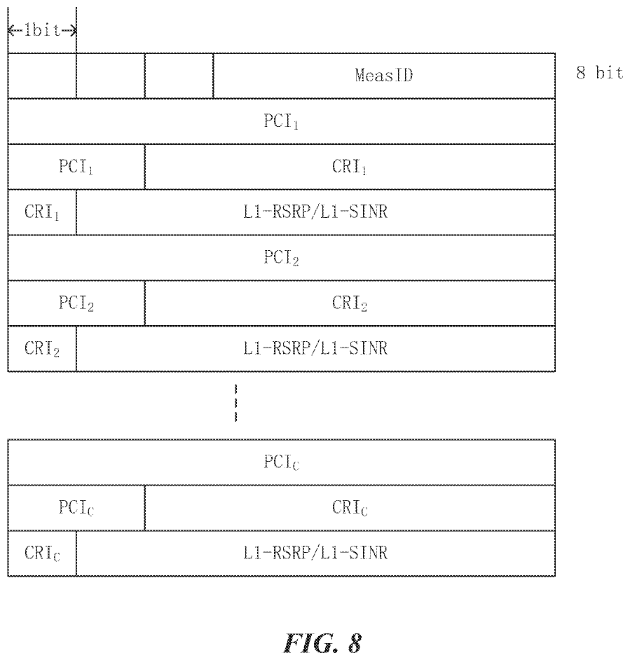

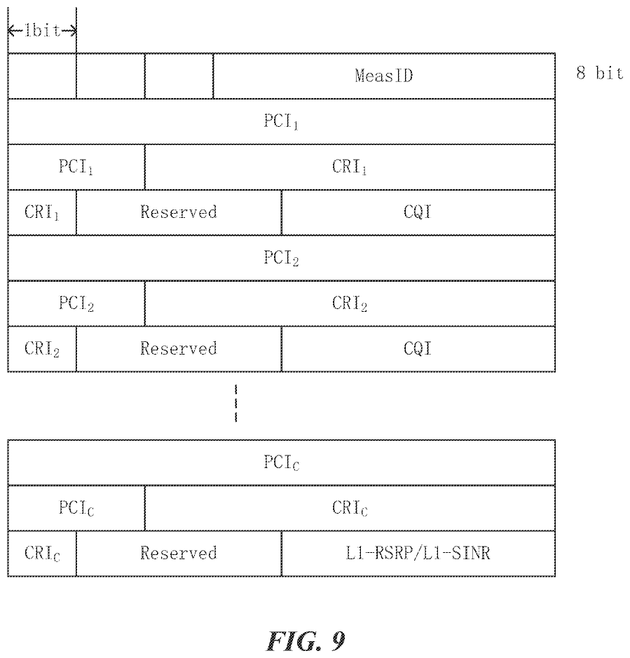

Method 3: The MAC-CE includes following information: one MeasID or one MeasObjectID, at least one PCI, L1 measurement information for each PCI, the reference signal resource index of the L1 measurement information of each PCI. FIGS. 8 and 9 show examples of MAC-CE corresponding to Method 3. Each PCI corresponds to one L1 measurement information which is associated with the best reference signal resource of the PCI, or which is associated with the reference signal resource index of the PCI regardless whether it is the best reference signal resource. In FIGS. 8 and 9, the reference signal resource index corresponds to CRI (CSI-RS resource indicator). However, the reference signal source index is not limited to CRI and the reference signal resource index can be CRI and/or SSB-RI (SSB-resource indicator). The number of the PCI in the MAC-CE will be a predetermined positive integer or a positive integer determined by a signaling from a gNB.

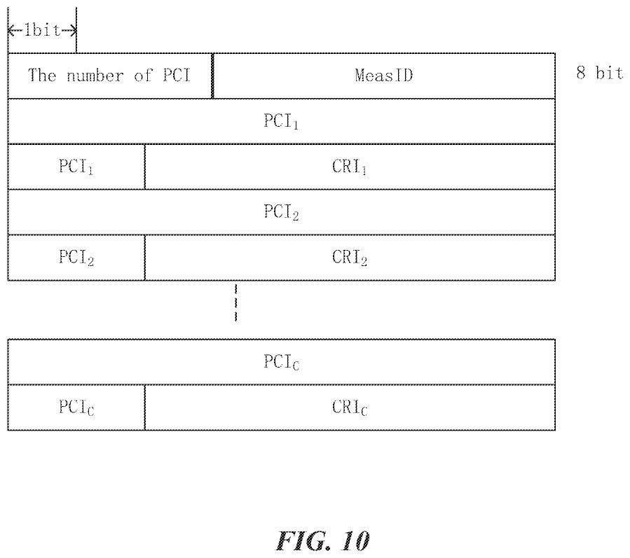

Method 4: The MAC-CE includes following information: one MeasID or one MeasObjectID, at least one PCI, and/or the reference signal resource index of each PCI. FIG. 10 shows an example of MAC-CE corresponding to Method 4. The L1 measurement information of the reference resource index in the MAC-CE is higher than a threshold.

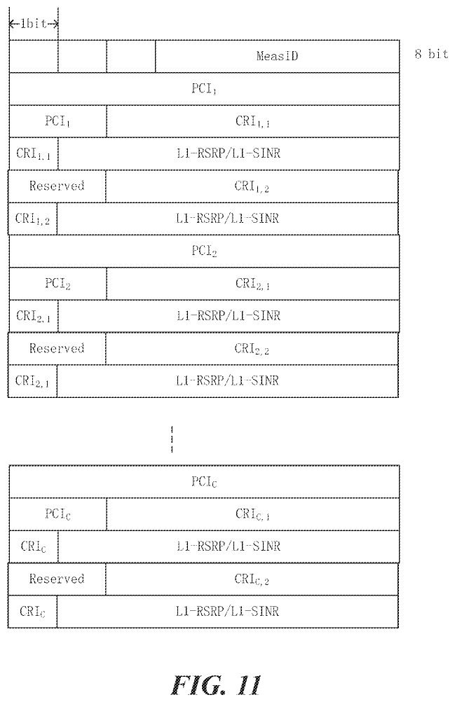

Method 5: The MAC-CE includes following information: one MeasID or one MeasObjectID, at least one PCI, one or more L1 measurement information for each PCI, the reference signal resource index of a L1 measurement information of each PCI. FIG. 11 shows an example of MAC-CE corresponding to Method 5. In FIG. 11, each PCI corresponds to two L1 measurement information. The different L1 measurement information of each PCI corresponds to different reference signal resources of the PCI. The number of reported reference signal resource indexes corresponding to each PCI will be a predetermined positive integer or a positive integer determined by a signaling from a gNB, or the maximum number of reported reference signal resource indexes corresponding to each PCI will be a predetermined positive integer or a positive integer determined by a signaling from a gNB. The numbers (or the maximum numbers) of reported reference signal resource indexes corresponding to different PCIs can be same or different. When they are different, the number (or the maximum number) of reported reference signal resource of each PCI will be configured respectively.

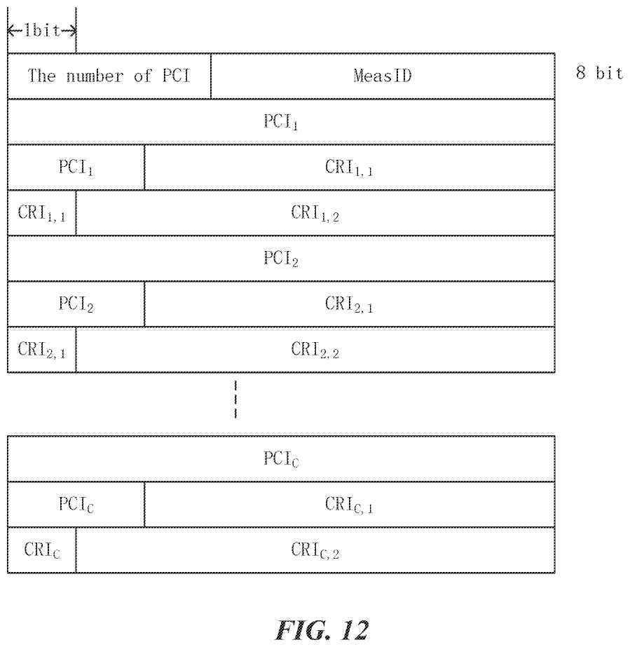

Method 6: The MAC-CE includes following information: one MeasID or one MeasObjectID, at least one PCI, and/or at least one reference signal resource index of each PCI. FIG. 12 shows an example of MAC-CE corresponding to Method 6. The L1 measurement information of the reference resource index in the MAC-CE is higher than a threshold.

In the methods above, the number of the PCI in the MAC-CE will be a predetermined positive integer or a positive integer determined by a signaling from a gNB. In some implementations, the maximum number of the PCI in the MAC-CE is a predetermined positive integer or a positive integer determined by a signaling from a gNB. The number of PCI in the MAC-CE can be included in the MAC-CE as shown in FIG. 7 or FIG. 12.

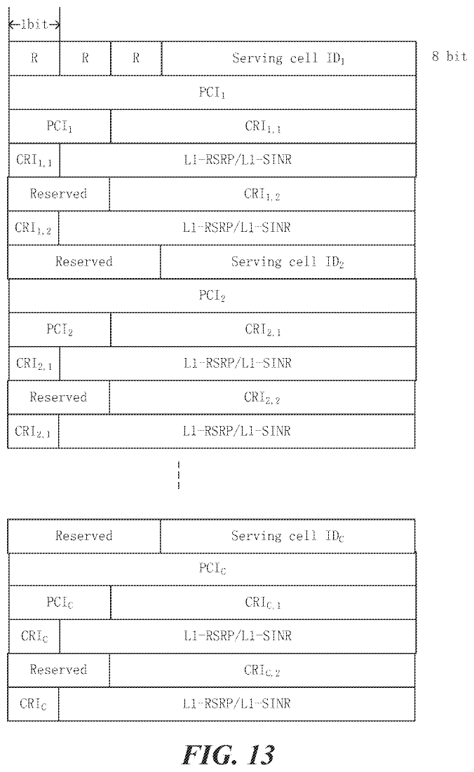

Method 7: The MAC-CE includes following information: at least one severing cell index, at least one neighboring cell PCI for each serving cell, one or more L1 measurement information for each neighboring cell PCI, and/or the reference signal resource index of each L1 measurement information of each PCI. FIG. 13 shows an example of MAC-CE corresponding to Method 7. The number of serving cells in the MAC-CE may be a predetermined positive integer or a positive integer determined by a signaling from a gNB. The number of neighboring cell corresponding to each serving cell will be a predetermined positive integer or a positive integer determined by a signaling from a gNB. The number of reported reference signal resource corresponding to one neighboring cell will be a predetermined positive integer or a positive integer determined by a signaling from a gNB.

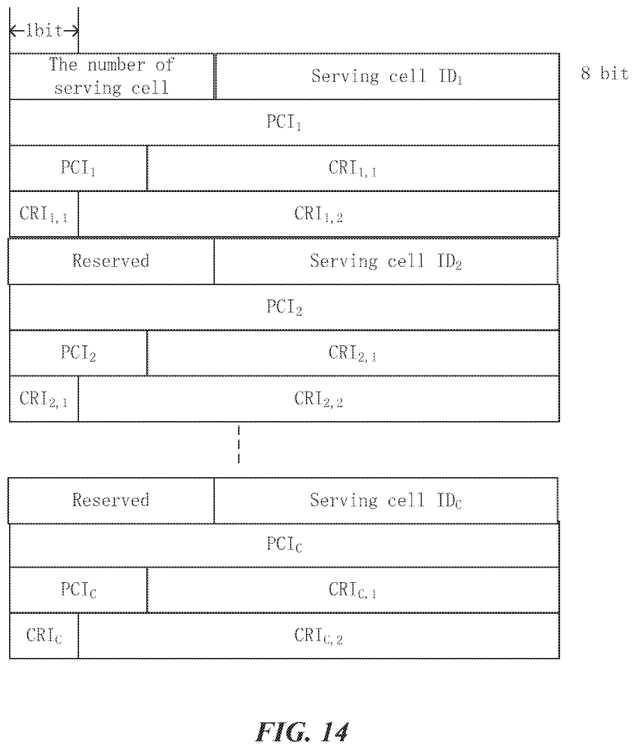

Method 8: The MAC-CE includes following information: at least one severing cell index, at least one neighboring cell PCI for each serving cell, and/or one or more of reference signal resource indexes of each PCI. FIG. 14 shows an example of MAC-CE corresponding to

Method 8. The L1 measurement information of the reference resource index in the MAC-CE is higher than a threshold.

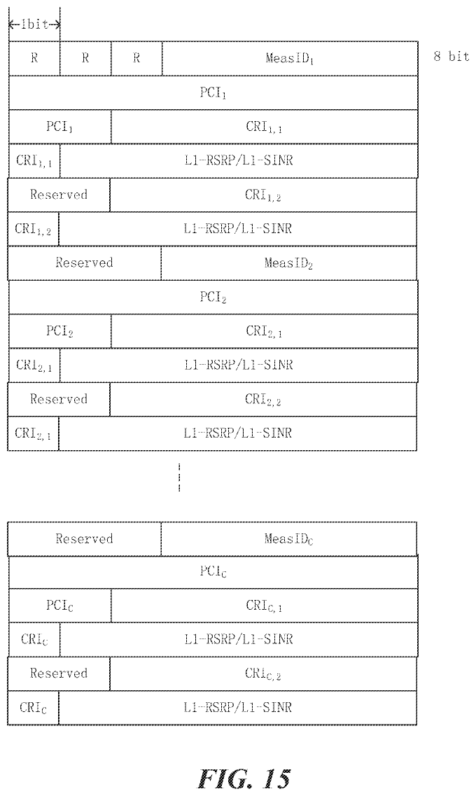

Method 9: The MAC-CE includes following information: at least one MeasID, at least one neighboring cell PCI for each MeasID, one or more L1 measurement information for each neighboring cell PCI, and/or the reference signal resource index of each L1 measurement information of each PCI. FIG. 15 shows an example of MAC-CE corresponding to Method 9. The number of MeasID in the MAC-CE be a predetermined positive integer or a positive integer determined by a signaling from a gNB. The number of neighboring cells corresponding to one MeasID will be a predetermined positive integer or a positive integer determined by a signaling from a gNB. The number of reference signal resource corresponding to one neighboring cell will be a predetermined positive integer or a positive integer determined by a signaling from a gNB.

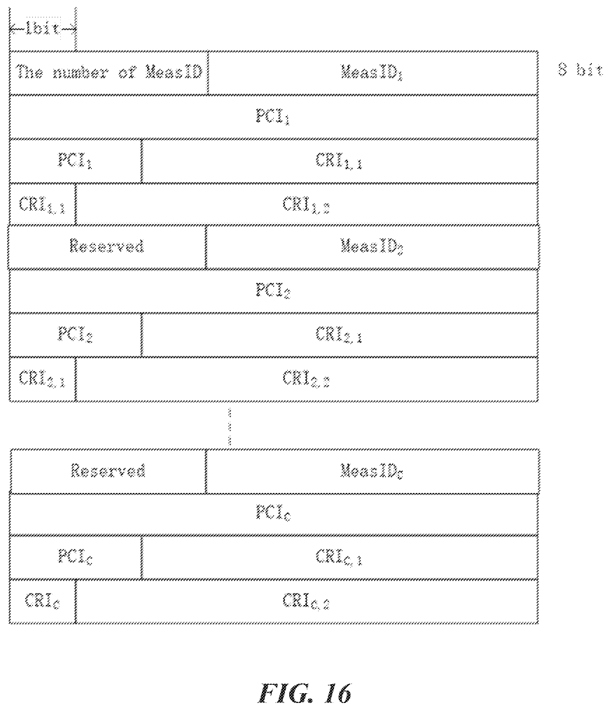

Method 10: The MAC-CE includes following information: at least one MeasID, at least one neighboring cell PCI for each MeasID, and/or one or more reference signal resource indexes of each PCI. FIG. 16 shows an example of MAC-CE corresponding to Method 10. The L1 measurement information of the reference resource index in the MAC-CE is higher than a threshold.

The numbers, e.g., the number of MeasID in the MAC-CE, the number of neighboring cells corresponding to one MeasID, the number of reference signal resource corresponding to one neighboring cell, may be determined by the UE and included in the MAC-CE as shown in FIG. 10, 12, 14, or 16 and the maximum number for each of these number is a predetermined positive integer or a positive integer determined by a signaling from a gNB.

The maximum number for these numbers can also depend on the capability which is reported by the UE.

When the MAC-CE includes more than one reference signal resource index for one PCI, the best L1 measurement information corresponding to the best reference signal resource index will be reported using an absolute value. Another L1 measurement information of another reference signal resource index of the PCI will be reported using a relative value. When the MAC-CE includes more than one L1 measurement information which include L1 measurement information for different reference signal resources of same or different PCIs, the best L1 measurement information will be reported using an absolute value. Another L1 measurement information will be reported using a relative value.

The quantity parameter used to quantity the L1 measurement information of the neighboring cell in the MAC-CE may be different (or same) from the quantity parameter used to quantity the L1 measurement information of the severing cell. The quantity parameter includes quantity step and/or quantity range.

The bit number in each field in the MAC-CE as shown in FIGS. 5 to 16 is an example only and can be modified. The order of these fields is also an example. The order may be other order. The PCI in the FIGS. 5 to 16 can be absolute value or a relative value. For example, the relative value of PCI is the index of the PCI reported among a predefined PCI set.

The L1 measurement information for at least one neighboring cell is reported in MAC-CE as shown in FIGS. 5 to 16. Similarly, the L1 measurement information for at least one neighboring cell can be reported in a UCI. The UE transmits the UCI (uplink control information) to report the neighboring cell L1 measurement information.

### EXAMPLE 3

When the UE determines that the condition to trigger a L1 measurement reporting of a neighboring cell is satisfied, the UE trigger a SR for reporting L1 measurement resource of neighboring cell. The L1 measurement reporting of a neighboring cell is included in a MAC-CE or a UCI.

In some implementations, if the UE needs to transmit SRs including a SR for beam failure recovery and another SR for reporting L1 measurement resource of neighboring cell, the UE selects one SR and transmits the selected SR. For example, the selected SR can be the another SR for reporting neighboring cell.

### EXAMPLE 4

When the UE determines to report L1 measurement information of a neighboring cell using a MAC-CE, the priority of the MAC-CE will be given a higher priority as the quality of serving cell is lower at this time. The UE should let the gNB known the L1 measurement information of a neighboring cell

### EXAMPLE 5

The gNB configure a CORESETpoolIndex for a CORESET or for a CORESET group using MAC-CE or DCI. The CORESETpoolIndex is used for determining at least one of following information: HARQ-ACK, the time domain relationship between PDSCH, the time domain relationship between PUSCH, the time domain relationship between HARQ-ACK with different PDSCHs. CORESETs with same CORESETpoolIndex can be a group of CORESET. When the CORESETpoolIndex is updated by the MAC-CE or DCI, the UE can determine above information according to the new updated CORESETPoolIndex.

When the number of CORESET associated with the same CORESETPoolIndex is larger than a threshold, the UE deactivated some CORESET according the index of CORESET or the index of search space associated with a CORESET.

In some implementations, the gNB configure the number of CORESETpoolIndex for a BWP, or for a CC, or for a CC group using MAC-CE or DCI. Then the CORESET group number will be updated more quickly.

In some implementation, the UE determines the CORESET pool index of a CORESET according to the PCI associated with the CORESET. For example, if the PCI is in a first PCI set, the CORESET pool index of the CORESET is 0. If the PCI is in a second PCI set, the CORESET pool index of the CORESET is 1. The gNB can update the PCI for a CORESET or for a CORESET pool. The PCI associated with a CORESET can be the PCI of the QCL-RS of the CORESET.

### EXAMPLE 6

The MAC-CE or DCI can deactivate a CORESET. Or the MAC-CE or DCI can deactivates a CORESET group associated with the same CORESETpoolIndex.

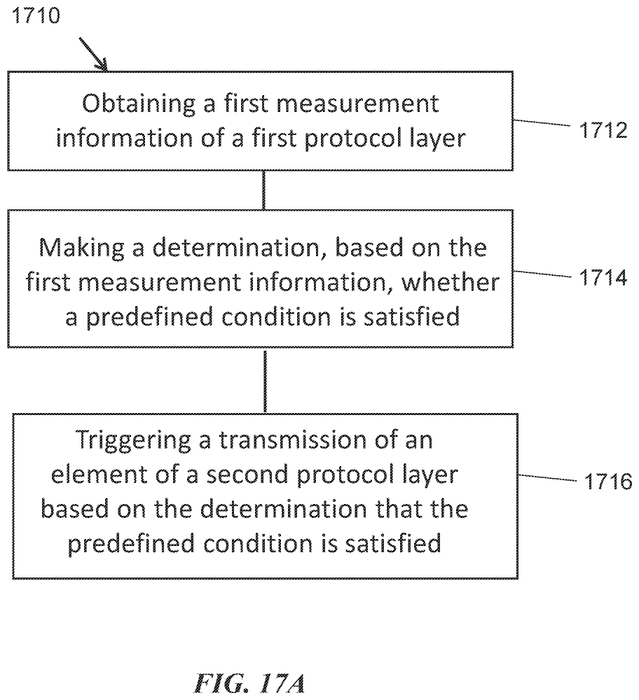

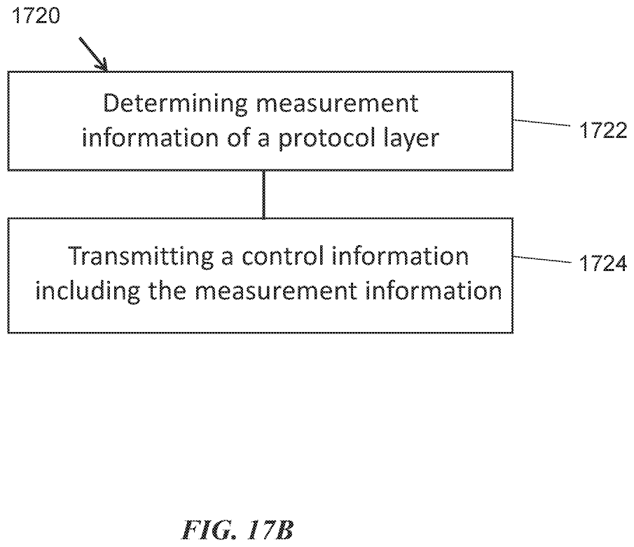

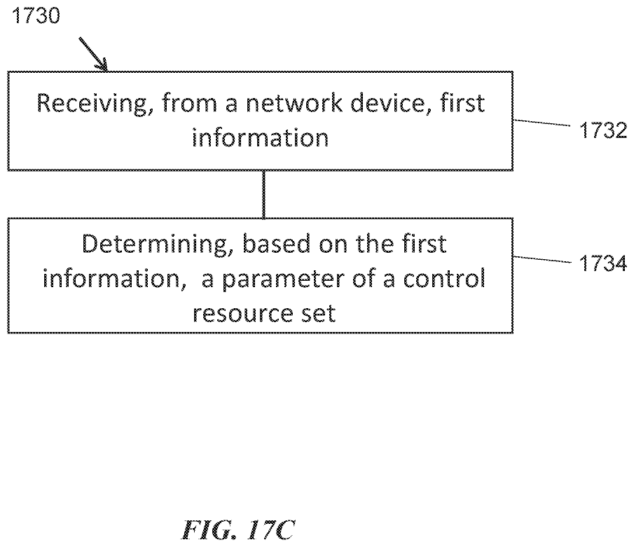

The implementations and examples of the wireless communication method disclosed above can facilitate measurement information reporting. FIG. 17A shows an example method 1710 showing operations of a user device based on some implementations of the disclosed technology. At operation 1712, the user device obtains a first measurement information of a first protocol layer. At operation 1714, the user device makes a determination, based on the first measurement information, whether a predefined condition is satisfied. At operation 1716, the user device triggers a transmission of an element of a second protocol layer based on the determination that the predefined condition is satisfied. In some implementations, the element of the second protocol layer includes at least one of control information of the second protocol layer or a second measurement information of the second protocol layer.

FIG. 17B shows another example method 1720 showing operations of a user device based on some implementations of the disclosed technology. At operation 1722, the user device determines measurement information of a protocol layer. At operation 1724, the user device transmits a control information including the measurement information. In some implementations, the protocol layer is a physical layer or a medium access control layer and the measurements information is for at least one of a neighboring cell or a serving cell.

FIG. 17C shows another example method 1730 showing operations of a user device based on some implementations of the disclosed technology. At operation 1732, the user device receives, from a network device, first information. At operation 1734, the user device determines, based on the first information, a parameter of a control resource set. In some implementations, the parameter includes at least one of: an index of the control resource set or a state of the control resource set. In some implementations, the first information includes at least one of MAC-CE (MAC Control Element), DCI (downlink control information), or PCI (physical layer cell ID) of the control resource set.

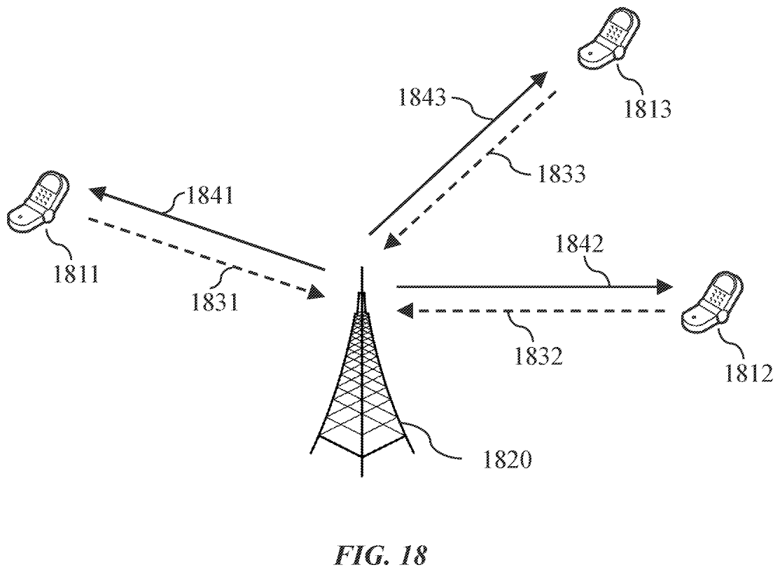

The implementations as discussed above will apply to a wireless communication. FIG. 18 shows an example of a wireless communication system (e.g., a 5G or NR cellular network) that includes a BS 1820 and one or more user equipment (UE) 1811, 1812 and 1813. In some embodiments, the UEs access the BS (e.g., the network) using implementations of the disclosed technology 1831, 1832, 1833), which then enables subsequent communication (1841, 1842, 1843) from the BS to the UEs. The UE may be, for example, a smartphone, a tablet, a mobile computer, a machine to machine (M2M) device, an Internet of Things (IoT) device, and so on.

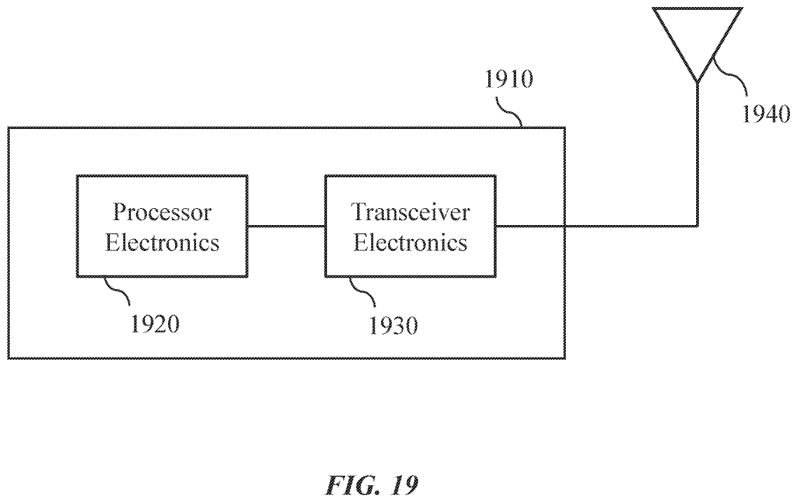

FIG. 19 shows an example of a block diagram representation of a portion of an apparatus. An apparatus 1910 such as a base station or a user device which may be any wireless device (or UE) can include processor electronics 1920 such as a microprocessor that implements one or more of the techniques presented in this document. The apparatus 410 can include transceiver electronics 430 to send and/or receive wireless signals over one or more communication interfaces such as antenna 440. The apparatus 410 can include other communication interfaces for transmitting and receiving data. The apparatus 410 can include one or more memories (not explicitly shown) configured to store information such as data and/or instructions. In some implementations, the processor electronics 420 can include at least a portion of transceiver electronics 430. In some embodiments, at least some of the disclosed techniques, modules or functions are implemented using the apparatus 410.

Additional features of the above-described methods/techniques that may be preferably implemented in some implementations are described below using a clause-based description format.

1. A method of wireless communication, the method performed by a user device and comprising: obtaining a first measurement information of a first protocol layer; making a determination, based on the first measurement information, whether a predefined condition is satisfied; and triggering a transmission of an element of a second protocol layer based on the determination that the predefined condition is satisfied, and wherein the element of the second protocol layer includes at least one of control information of the second protocol layer or a second measurement information of the second protocol layer.

2. The method of clause 1, further comprising: triggering a reporting of a third measurement information of the first protocol layer based on the determination that the predefined condition is satisfied.

3. The method of clause 1, wherein the predefined condition includes one of: 1) a neighbor cell becomes offset than a special cell (SpCell)); 2) the SpCell becomes worse than threshold1 and the neighbor cell becomes better than threshold2; 3) a primary serving cell (PCell) becomes worse than the threshold1 and inter RAT neighbor cell becomes better than the threshold2; 4) the neighbor cell becomes offset6 than a secondary cell (Scell); 5) a serving cell becomes worse than threshold; the neighbor cell becomes better than the threshold; 6) the serving cell becomes better than the threshold; 7) the serving cell is better than the threshold and the neighboring cell is better than the threshold; 8) the serving cell becomes worse than the threshold1 and at least two neighboring cells become better than the threshold2; 9) at least two neighboring cells become better than the threshold2; 10) a condition indicating an expiration of a timer; 11) a condition indicating a period of a measurement reporting of the first protocol layer; or 12) a condition to trigger a measurement reporting of the first protocol layer.

4. The method of clause 1, wherein the element includes at least one of MAC-CE (MAC Control Element), SR (Scheduling Request), or UCI (Uplink Control Information).

5. The method of clause 4, wherein the SR is triggered if a cell corresponding to the second measurement information includes one of: a neighboring cell corresponding to a serving cell; a best neighboring cell corresponding to a serving cell; a neighboring cell corresponding to a predefined serving cell; a best neighboring cell corresponding to a predefined serving cell; best N neighboring cell associated with a measurement identification (measID).

6. The method of clause 4, wherein the element includes SR and the method further comprises: determining a priority between the SR and another SR triggered by beam failure.

7. The method of clause 6. wherein the SR has higher priority than the another SR triggered by beam failure.

8. The method of clause 1, wherein further comprising: determining a first parameter associated with the transmission of the element of the second protocol layer, wherein the first parameter is configured by a network device or predefined and is a measurement parameter of the first protocol, or determining a second parameter associated with the first measurement information, wherein the second parameter is configured by a network device or predefined and is a parameter of the element.

9. The method of clause 8, wherein the first parameter includes at least one of: a measurement identification that links one measurement object with one reporting configuration, a serving cell index, a measurement object index, a reporting index, or an event index.

10. The method of clause 1, wherein the control information includes at least one of i) the second measurement information; ii) measurement information of a third protocol layer; iii) one or more physical cell index; iv) another measurement information of the first protocol layer; v) one or more reference signal resource index; vi) one or more measurement identification (MeasID); vii) one or more measurement object (MeasObjectID); viii) one or more serving cell index; ix) a number of physical cell indices; x) a number of MeasID; xi) a number of serving cell index, wherein the second measurement information, the measurement information of the third protocol layer, and the another measurement information corresponds to a cell or a reference signal resource of the cell, the cell including at least one of a neighboring cell or a serving cell.

11. The method of clause 10, wherein the third protocol layer corresponds to a physical layer.

12. The method of clause 1, wherein the control information includes at least one of i) measurement information for a serving cell; ii) measurement information for a neighboring cell; iii) measurement information for a measurement object (MeasObject); or iv) measurement information for a measurement identification (MeasID).

13. The method of clause 1, wherein the second measurement information is determined based on a fourth measurement information of the first protocol layer.

14. The method of clause 13, wherein a physical cell index(s) associated with the second measurement information belongs to the fourth measurement information.

15. The method of clause 1, wherein the first measurement information is filtered by a filter having a parameter that is informed by a network device or predefined.

16. The method of clause 1, wherein the first protocol layer and the second protocol layer a same protocol layer.

17. The method of any of clauses 1 to 16, wherein the first protocol layer corresponds to a radio resource control layer and the second protocol layer corresponds to a physical layer.

18. The method of any of clauses 1 to 16, wherein the first protocol layer corresponds to a radio resource control layer and the second protocol layer corresponds to a medium access control layer.

19. The method of any of clauses 1 to 16, wherein a time domain behavior parameter of the transmission is configured or is predefined, and wherein the time domain behavior parameter includes at least one of: a period, an offset, a transmission number, or a condition to stop.

20. A method of wireless communication, the method performed by a user device and comprising: determining measurement information of a protocol layer; and transmitting a control information including the measurement information, and wherein the protocol layer is a physical layer or a medium access control layer and the measurements information is for at least one of a neighboring cell or a serving cell.

21. The method of clause 20, wherein the transmitting of the control information is triggered by one of i) a signaling from a network device; ii) the determining that a condition related to the measurement information is met; iii) the determining that a condition related to another measurement information of another protocol layer is met; or iv) detecting a beam failure.

22. The method of clause 20, wherein the measurement information of the protocol layer is determined based on a measurement information of another protocol layer.

23. The method of clause 22, wherein a physical cell index(s) associated with the measurement information of the protocol layer belongs to the measurement information of the another protocol layer.

24. The method of any of clauses 21 to 23, wherein the another protocol layer corresponds to a radio resource control layer.

25. The method of clause 20, wherein the control information corresponds to a MAC-CE (MAC Control Element), SR (Scheduling Request), or UCI (Uplink Control Information).

26. The method of clause 20, wherein the control information includes at least one items of i) one or more measurement identifications (MeasIDs); ii) one or more measurement objects (MeasObjectIDs); iii) one or more serving cell indices; iv) one or more PCIs; v) the measurement information; vi) one or more reference signal resource indices; vii) a number of PCI; viii) a number of MeasID; or viii) a number of serving cell index, and wherein the measurement information corresponds to a cell or a reference signal resource of the cell, the cell including at least one of the neighboring cell or the serving cell.

27. The method of clause 26, wherein the one or more PCIs have a relative value.

28. The method of clause 20, wherein the measurement information includes one of: L1 -SINR (signal-to-noise and interference ratio), L1-RSRP (reference signal received power), CQI (channel quality indicator).

29. The method of clause 26, wherein the one or more PCIs correspond to one of one measurement identification (MeasIDs), one measurement objection (MeasObjectID), or one serving cell index.

30. The method of clause 26, wherein the one or more reference signal resource indices include one or more reference signal resource index group, each group corresponding to one of one measurement identification (MeasIDs), one measurement objection (MeasObjectID), or one serving cell index.

31. The method of clause 26, wherein at least one of following is determined by the user device or based on a signaling from a network device: i) a number of the measurement identifications (MeasIDs), ii) a number of neighboring cells corresponding to one measurement identification (MeasID), iii) a number of serving cells, iv) a number of pieces of the measurement information corresponding to one PCI, or v) a number of reference signal resources corresponding to one PCI.

32. The method of clause 26, wherein at least one of following is determined by a signaling from a network device: i) a maximum number of measurement identifications (MeasIDs), ii) a maximum number of neighboring cells corresponding to one measurement identification (Meas ID), iii) a maximum number of serving cells, iv) a maximum number of pieces of the measurement information corresponding to one PCI, or v) a maximum number of reference signal resources corresponding to one PCI.

33. The method of clause 20, wherein a type of the measurement information depends on configuration information received from a network device.

34. The method of clause 20, wherein a quantity parameter that is used to quantity the measurement information is different from another quantity parameter used to quantity another measurement information of the protocol layer.

35. The method of clause 20, further comprising: reporting a capability of the user device, the capability includes at least one of: i) a maximum number of measurement identifications (MeasIDs) that are included in one piece of the control information, ii) a maximum number of neighboring cells corresponding to one measurement identification (Meas ID), iii) a maximum number of serving cells that are included in one piece of the control information, iv) a maximum number of pieces of the measurement information corresponding to one PCI, v) a maximum number of reference signal resources corresponding to one PCI; vi) a maximum number of PCI whose the measurement information of the protocol layer can be reported; vi) a maximum number of reference signal resources whose the measurement information of the protocol layer can be reported; vii) a maximum number of reference signal resources whose measurement information of the protocol layer is capable of being reported; viii) a maximum number of reference signal resources per PCI whose measurement information of the protocol layer is capable of being reported.

36. A method of wireless communication, the method performed by a user device and comprising: receiving, from a network device, first information; and determining, based on the first information, a parameter of a control resource set, and wherein the parameter includes at least one of: an index of the control resource set or a state of the control resource set, and wherein the first information includes at least one of MAC-CE (MAC Control Element), DCI (downlink control information), or PCI (physical layer cell ID) of the control resource set.

37. The method of clause 35, further comprising: determining, based on the parameter, at least one of a hybrid automatic repeat request ack (HARQ-ACK), a time domain relationship between two physical downlink channels (PDSCHs), a time domain relationship between two physical uplink shared channels (PUSCHs), a time domain relationship between a HARQ-ACK with different PDSCHs.

38. The method of clause 35, further comprising: deactivating some resources of the control resource set based on the index of the control resource set or another index of a search space associated with the control resource set in case that a number of the control resource set associated with the index is greater than a threshold.

39. A communication apparatus comprising a processor configured to implement a method recited in any one or more of clauses 1 to 38.

40. A computer readable medium having code stored thereon, the code, when executed, causing a processor to implement a method recited in any one or more of clauses 1 to 38.

In some embodiments, a base station may be configured to implement some or all of the base station side techniques described in the present document.

It is intended that the specification, together with the drawings, be considered exemplary only, where exemplary means an example and, unless otherwise stated, does not imply an ideal or a preferred embodiment. As used herein, the use of “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, the method performed by a user device and comprising:
obtaining a first measurement information of a first protocol layer;
making a determination, based on the first measurement information, whether a predefined condition is satisfied;
triggering a transmission of an element of a second protocol layer based on the determination that the predefined condition is satisfied, and
wherein the element of the second protocol layer includes at least one of control information of the second protocol layer or a second measurement information of the second protocol layer, and
wherein the method further comprises: triggering a reporting of a third measurement information of the first protocol layer based on the determination that the predefined condition is satisfied.

2. The method of claim 1, wherein the predefined condition includes one of: 1) a neighbor cell becomes offset than a special cell (SpCell)); 2) the SpCell becomes worse than a first threshold and the neighbor cell becomes better than a second threshold; 3) a primary serving cell (PCell) becomes worse than the first threshold and inter RAT neighbor cell becomes better than the second threshold; 4) the neighbor cell becomes offset6 than a secondary cell (Scell); 5) a serving cell becomes worse than a third threshold; the neighbor cell becomes better than the third threshold; 6) the serving cell becomes better than the third threshold; 7) the serving cell is better than the third threshold and the neighboring cell is better than the third threshold; 8) the serving cell becomes worse than the first threshold and at least two neighboring cells become better than the second threshold; 9) at least two neighboring cells become better than the second threshold; 10) a condition indicating an expiration of a timer; 11) a condition indicating a period of a measurement reporting of the first protocol layer; or 12) a condition to trigger a measurement reporting of the first protocol layer.

3. The method of claim 1, wherein the element includes a SR (Scheduling Request) and the SR is triggered if a cell corresponding to the second measurement information includes one of: a neighboring cell corresponding to a serving cell; a best neighboring cell corresponding to a serving cell; a neighboring cell corresponding to a predefined serving cell; a best neighboring cell corresponding to a predefined serving cell; best N neighboring cell associated with a measurement identification (measID).

4. The method of claim 1, wherein the element includes a SR (Scheduling Request) and the method further comprises determining a priority between the SR and another SR triggered by beam failure, and wherein the SR has higher priority than the another SR triggered by beam failure.

5. The method of claim 1, wherein further comprising:
determining a first parameter associated with the transmission of the element of the second protocol layer, wherein the first parameter is configured by a network device or predefined and is a measurement parameter of the first protocol, or
determining a second parameter associated with the first measurement information, wherein the second parameter is configured by a network device or predefined and is a parameter of the element, and
wherein the first parameter includes at least one of: a measurement identification that links one measurement object with one reporting configuration, a serving cell index, a measurement object index, a reporting index, or an event index.

6. The method of claim 1, wherein the control information includes at least one of i) the second measurement information; ii) measurement information of a third protocol layer; iii) one or more physical cell index; iv) another measurement information of the first protocol layer; v) one or more reference signal resource index; vi) one or more measurement identification (MeasID); vii) one or more measurement object (MeasObjectID); viii) one or more serving cell index; ix) a number of physical cell indices; x) a number of MeasID; xi) a number of serving cell index, wherein the second measurement information, the measurement information of the third protocol layer, and the another measurement information corresponds to a cell or a reference signal resource of the cell, the cell including at least one of a neighboring cell or a serving cell, and wherein the third protocol layer corresponds to a physical layer.

7. The method of claim 1, wherein the control information includes at least one of i) measurement information for a serving cell; ii) measurement information for a neighboring cell; iii) measurement information for a measurement object (MeasObject); or iv) measurement information for a measurement identification (MeasID).

8. The method of claim 1, wherein the second measurement information is determined based on a fourth measurement information of the first protocol layer, wherein a physical cell index(s) associated with the second measurement information belongs to the fourth measurement information, and wherein the first measurement information is filtered by a filter having a parameter that is informed by a network device or predefined.

9. The method of claim 1, wherein the first protocol layer corresponds to a radio resource control layer, wherein the second protocol layer corresponds to a physical layer or a medium access control layer, wherein a time domain behavior parameter of the transmission is configured or is predefined, and wherein the time domain behavior parameter includes at least one of: a period, an offset, a transmission number, or a condition to stop.

10. A method of wireless communication, the method performed by a user device and comprising:
determining measurement information of a protocol layer; and
transmitting a control information including the measurement information, and
wherein the protocol layer is a physical layer or a medium access control layer and the measurements information is for at least one of a neighboring cell or a serving cell.

11. The method of claim 10, wherein the transmitting of the control information is triggered by one of i) a signaling from a network device; ii) the determining that a condition related to the measurement information is met; iii) the determining that a condition related to another measurement information of another protocol layer is met; or iv) detecting a beam failure.

12. The method of claim 10, wherein the measurement information of the protocol layer is determined based on a measurement information of another protocol layer, wherein a physical cell index(s) associated with the measurement information of the protocol layer belongs to the measurement information of the another protocol layer, and wherein the another protocol layer corresponds to a radio resource control layer.

13. The method of claim 10, wherein the control information corresponds to a MAC-CE (MAC Control Element), SR (Scheduling Request), or UCI (Uplink Control Information), and, wherein the control information includes at least one items of i) one or more measurement identifications (MeasIDs); ii) one or more measurement objects (MeasObjectIDs); iii) one or more serving cell indices; iv) one or more PCIs corresponding to one of one measurement identification (MeasIDs), one measurement objection (MeasObjectID), or one serving cell index; v) the measurement information; vi) one or more reference signal resource indices including one or more reference signal resource index group, each group corresponding to one of one measurement identification (MeasIDs), one measurement objection (MeasObjectID), or one serving cell index; vii) a number of PCI; viii) a number of MeasID; or viii) a number of serving cell index, and wherein the measurement information corresponds to a cell or a reference signal resource of the cell, the cell including at least one of the neighboring cell or the serving cell.

14. The method of claim 10, wherein the measurement information includes one of: L1-SINR (signal-to-noise and interference ratio), L1-RSRP (reference signal received power), CQI (channel quality indicator).

15. The method of claim 13, wherein at least one of following is determined by the user device or based on a signaling from a network device: i) a number of the measurement identifications (MeasIDs), ii) a number of neighboring cells corresponding to one measurement identification (Meas ID), iii) a number of serving cells, iv) a number of pieces of the measurement information corresponding to one PCI, or v) a number of reference signal resources corresponding to one PCI, or
wherein at least one of following is determined by a signaling from a network device: i) a maximum number of measurement identifications (MeasIDs), ii) a maximum number of neighboring cells corresponding to one measurement identification (Meas ID), iii) a maximum number of serving cells, iv) a maximum number of pieces of the measurement information corresponding to one PCI, or v) a maximum number of reference signal resources corresponding to one PCI.

16. The method of claim 10, wherein a type of the measurement information depends on configuration information received from a network device, and wherein a quantity parameter that is used to quantity the measurement information is different from another quantity parameter used to quantity another measurement information of the protocol layer.

17. The method of claim 10, further comprising:
reporting a capability of the user device, the capability includes at least one of: i) a maximum number of measurement identifications (MeasIDs) that are included in one piece of the control information, ii) a maximum number of neighboring cells corresponding to one measurement identification (Meas ID), iii) a maximum number of serving cells that are included in one piece of the control information, iv) a maximum number of pieces of the measurement information corresponding to one PCI, v) a maximum number of reference signal resources corresponding to one PCI; vi) a maximum number of PCI whose the measurement information of the protocol layer can be reported; vi) a maximum number of reference signal resources whose the measurement information of the protocol layer can be reported; vii) a maximum number of reference signal resources whose measurement information of the protocol layer is capable of being reported; viii) a maximum number of reference signal resources per PCI whose measurement information of the protocol layer is capable of being reported.

18. A method of wireless communication, the method performed by a user device and comprising:
receiving, from a network device, first information; and
determining, based on the first information, a parameter of a control resource set, and
wherein the parameter includes at least one of: an index of the control resource set or a state of the control resource set, and
wherein the first information includes at least one of MAC-CE (MAC Control Element), DCI (downlink control information), or PCI (physical layer cell ID) of the control resource set.

19. The method of claim 18, further comprising: determining, based on the parameter, at least one of a hybrid automatic repeat request ack (HARQ-ACK), a time domain relationship between two physical downlink channels (PDSCHs), a time domain relationship between two physical uplink shared channels (PUSCHs), a time domain relationship between a HARQ-ACK with different PDSCHs.

20. The method of claim 18, further comprising: deactivating some resources of the control resource set based on the index of the control resource set or another index of a search space associated with the control resource set in case that a number of the control resource set associated with the index is greater than a threshold.
